(19) United States
(12) Patent Application Publication
(10) Pub. No.: US 2023/0288269 A1
(43) Pub. Date: Sep. 14, 2023

(54) METHOD, COMPUTER PROGRAM AND DEVICE FOR MONITORING AN INDUCTIVE COMPONENT

(71) Applicant: Fraunhofer-Gesellschaft zur Förderung der angewandten Forschung e.V., MUNICH (DE)

(72) Inventors: William KAAL, DARMSTADT (DE); Andreas FRIEDMANN, DARMSTADT (DE)

(21) Appl. No.: 17/996,351

(22) PCT Filed: Mar. 25, 2021
(86) PCT No.: PCT/EP2021/057853

§ 371 Date: Oct. 17, 2022

(30) Foreign Application Priority Data
Apr. 17, 2020 (DE) 10 2020 110 534.7

(51) Int. Cl. G01L 1/10; G01L 1/22

(52) U.S. Cl. CPC G01L 1/10; G01L 1/225; G01L 1/2268

(57) ABSTRACT

Embodiments of the present disclosure relate to a method (100) in particular for checking a mechanical stress acting on an inductive component (210). The method (100) comprises sensing (110) one or more measured quantities dependent on the mechanical stress when an electrical excitation signal is applied to the inductive component (210). Further, the method (100) comprises determining (120) the mechanical stress acting on the inductive component (210) based on the one or more sensed measured quantities.

### TECHNICAL FIELD

Embodiments relate to a method, computer program, and apparatus for checking an inductive component. In particular, embodiments of the present invention relate to a method, computer program, and apparatus for checking a load on a coil of the inductive component.

### BACKGROUND

In induction furnaces, an electromagnetic field is generated by a coil for inductive heating of a molten material. The electromagnetic field may interact with the coil in such a way that the electromagnetic field exerts axially and radially acting forces on the coil. In order to prevent movements and/or formings/deformations of the coil caused by this, it may be mechanically fixed and prestressed. A reduction or even a loss of prestress and thus possible movements or deformations of the coil during operation may have self-reinforcing effects which may damage or destroy the coil itself and other components of the induction furnace. This reduces, for example, a tool life of a crucible of the induction furnace. Alternatively, or additionally, such effects may also result in a reduction of a service life of the coil and its concrete anchors with which the coil is fixed in the induction furnace.

A known procedure for ensuring the prestressing of the coil provides for checking a torque of screw connections of the concrete anchors at predetermined time intervals and readjusting them if necessary.

Such a procedure to ensure the prestressing of the coil may involve additional amount of work in operating the coil.

Therefore, one task of the present invention may be seen in providing an improved concept for checking a mechanical stress acting on an inductive component.

### SUMMARY

This task may be solved by means of the independent and dependent claims.

According to a first aspect, embodiments of the present disclosure relate to a method in particular for checking a mechanical stress acting on an inductive component. The method comprises sensing one or more measured quantities dependent on the mechanical stress when an electrical excitation signal is applied to the inductive component. Further, the method comprises determining the mechanical stress acting on the inductive component based on the one or more sensed measured quantities.

The inductive component may be understood in particular as an electrical component or an electrical circuit which, based on the law for electromagnetic induction, is suitable for generating an alternating electromagnetic field. The inductive component comprises, for example, a transformer (trafo) and/or a coil.

In some application examples, the inductive component and/or parts of the inductive component, such as the coil, may be mechanically fixed or supported so that mechanical stress is acting on the inductive component. The mechanical stress may therefore be understood as a mechanical prestress in some application examples.

The electrical excitation signal may correspond to either an electrical energy supply intended to operate the inductive component or an electrical test signal intended to check the inductive component. The electrical excitation signal is applied to the inductive component, for example, by means of a signal generator coupled to the inductive component. The electrical excitation signal is, for example, a current/voltage alternating signal.

When the electrical excitation signal is applied, the inductive component may generate an electromagnetic field. A behavior of the inductive component characterized by the measured quantities when interacting with the electromagnetic field may depend in particular on the mechanical stress acting on the inductive component. Therefore, the one or more measured quantities may be used to infer, in particular, the mechanical stress acting on the inductive component.

The one or more measured quantities are, for example, electrical or mechanical measured quantities that indicate the behavior of the inductive component when interacting with the electromagnetic field generated by the inductive component. It should also be noted that if “the measured quantities” are referred to below, they refer to the one or more measured quantities.

The measured quantities may have a certain ratio to the mechanical stress acting on the inductive component, so that knowing the ratio, it is possible to infer the mechanical stress from the measured quantities. A processor is, for example, used to determine the mechanical stress.

Such a procedure may require less amount of work compared to known procedures for ensuring the prestress of the coil. In addition, cost savings and time savings in checking the inductive component may be achieved in this way.

The mechanical stress acting on the inductive component may be in particular characteristic of wear effects and/or formings/deformations of the inductive component. The method described above may therefore be used in particular to identify wear effects and/or formings/deformations of the inductive component. Wear effects are, for example, an evaporation of coil material of a coil of the inductive component or plastic deformations of the coil due to thermal influences during operation of the coil.

In some embodiments, the one or more measured quantities comprise vibration information about mechanical vibrations of the inductive component when the electrical excitation signal is applied. Determining the mechanical stress may comprise determining the mechanical stress based on the vibration information.

For example, the mechanical vibrations of the inductive component are an effect of the interaction of the inductive component with the electromagnetic field generated by the same. The mechanical vibrations may depend in particular on the mechanical stress acting on the inductive component. Therefore, the mechanical stress may be inferred from the vibration information about the mechanical vibrations of the inductive component.

The mechanical vibrations may preferably be measured without contact and without influencing the electrical behavior of the inductive component in order to sense the vibration information.

In some embodiments, the vibration information comprises at least a frequency, a frequency spectrum, an amplitude or an overtone or undertone of the mechanical vibration.

Depending on the mechanical stress, the frequency, the frequency spectrum, the amplitude, and/or an overtone or undertone generated by the mechanical vibrations of the inductive component may be different. Therefore, the mechanical stress may be determined based on the frequency, the frequency spectrum, the amplitude, the overtone generated, and/or the undertone.

Optionally, the mechanical stress may be determined using one of the previously mentioned measured quantities. For a more accurate or reliable determination of the mechanical stress, a combination of these may optionally be used.

In some embodiments, the method comprises sensing the vibration information based on an airborne sound generated by the inductive component.

In the context of the present disclosure, airborne sound may be understood to mean, in particular, sound waves generated by the mechanical vibrations of the inductive component and thus characteristic, for example, of the frequency or amplitude of the mechanical vibration of the inductive component.

The airborne sound is measured to identify the vibration information, for example, with a sound transducer such as a microphone.

In this way, the mechanical stress may be determined without contact.

In some embodiments, the method comprises sensing the vibration information based on a structure-borne sound generated by the inductive component.

The structure-borne sound may refer to a sound that propagates within the inductive component or another body excited by the vibration of the inductive component. The structure-borne sound is thus characteristic, for example, of the frequency or the amplitude of the mechanical vibration of the inductive component and may be measured, for example, by means of an electromagnetic, electrodynamic or piezoelectric pickup in order to sense the vibration information.

For example, sensing vibration information based on the structure-borne sound generated by the inductive component is less susceptible to noise interference than sensing the vibration information based on the airborne sound generated by the inductive component.

In some embodiments, the one or more measured quantities dependent on the mechanical stress comprise an electrical impedance of the inductive component. Determining the mechanical stress may comprise determining the mechanical stress based on the electrical impedance.

The vibration information may, alternatively or additionally, be identified based on the electrical excitation signal, such as based on an electric voltage, an electric current, or the resulting electrical impedance of the inductive component. Therefore, the electrical impedance may be used to identify the mechanical stress acting on the inductive component.

For example, the electrical impedance is identified based on an electric voltage and an electric current of the electrical excitation signal. A current measuring device and a voltage measuring device may be used to measure the electrical impedance.

In some applications, appropriate measuring devices for identifying the electric voltage of the electric current of the electrical excitation signal may already be provided, so that no additional measuring devices, such as for measuring the structure-borne sound or airborne sound, are required compared to previously described application examples.

For higher reliability in determining the mechanical stress acting on the inductive component, it may optionally be determined based on the electrical impedance and vibration information about mechanical vibrations of the inductive component.

In some embodiments, determining the mechanical stress based on the one or more measured quantities comprises determining the mechanical stress based on a comparison of the electrical excitation signal to the one or more measured quantities.

Since the behavior of the inductive component, and/or the interaction of the inductive component with the generated electromagnetic field, may depend in particular on the electrical excitation signal, it may be advantageous to identify the mechanical stress by comparing the one or more previously mentioned measured quantities with the electrical excitation signal. For example, the mechanical stress may be identified based on a ratio of a frequency of the electric voltage and/or the current strength of the electrical excitation signal and the frequency of the mechanical vibrations of the inductive component. Optionally, to determine the mechanical stress, an amplitude of the electric voltage and/or the current strength may be compared to the amplitude of the mechanical vibrations.

In this way, influences of the electrical excitation signal on a determination of the mechanical stress may be at least partially compensated.

In some embodiments, the method further comprises identifying one or more influencing quantities that affect the one or more measured quantities when the electrical excitation signal is applied. Accordingly, determining the mechanical stress may comprise determining the mechanical stress based on the one or more influencing quantities and the one or more measured quantities.

The influencing quantities comprise, for example, an ambient temperature, a humidity, and/or a temperature of the inductive component. Such influencing quantities may have an impact on mechanical and electrical properties of the inductive component and thus influence the one or more measured quantities when the electrical excitation signal is applied.

For at least partial compensation of an influence of the influencing quantities and/or for error estimation when determining the mechanical stress acting on the inductive component, the previously mentioned influencing quantities may therefore be used in addition to the measured quantities dependent on the mechanical stress when determining the mechanical stress.

In some embodiments, the method further comprises configuring a data processing structure for determining the mechanical stress acting on the inductive component based on the one or more measured quantities by means of machine learning using the one or more measured quantities and one or more reference values for the mechanical stress of the inductive component as input quantities for the machine learning.

In this context, the reference values may be understood as training data, on the basis of which and the previously mentioned measured quantities as input quantities the data processing structure may develop a model or an algorithm for determining the stress acting on the inductive component, for example by means of supervised learning, semi-supervised learning, unsupervised learning or reinforcement learning.

The reference values are, for example, values for the mechanical stress, which were identified mechanically. The reference values may be derived, for example, based on torques of screws with which the windings of the coil of the inductive component are prestressed in the radial direction.

The data processing structure may be understood, for example, as a processor, a microcontroller, or any other programmable hardware component. In machine learning, an adjustment of an artificial neural network operated by the data processing structure may be adjusted.

For the person skilled in the art, it is understood that through machine learning, the aforementioned model may be specifically adjusted to circumstances of a desired use case and thus provide more accurate results for the mechanical stress acting on the inductive component than any predetermined model for determining the mechanical stress.

In some embodiments, the inductive component comprises at least one coil onto which the mechanical stress is applied. Accordingly, the method may comprise sensing the one or more measured quantities dependent on the mechanical stress when the electrical excitation signal is applied to the at least one coil. Further, the method comprises determining the mechanical stress acting on the at least one coil based on the one or more sensed measured quantities.

The coil is configured, for example, as an induction coil or a transformer coil and is fixed under a mechanical prestress by means of fastening means.

In some embodiments, the at least one coil is configured to inductively heat a molten material arranged within the at least one coil when the electrical excitation signal is applied to the at least one coil.

The coil is designed, for example, as an induction coil of a melting furnace, which is arranged around a crucible of the melting furnace and is fixed by means of fastening means under mechanical prestress.

If the mechanical prestress of the induction coil is insufficient, mechanical behavior of the induction coil when the electrical excitation signal is applied to heat the molten material may cause increased wear of the crucible. The method described above may therefore be used, in particular, to ensure sufficient prestress of the induction coil in order to reduce crucible wear.

In some embodiments, sensing the one or more measured quantities comprises sensing one or more first measured values of the one or more measured quantities at a first time and sensing one or more second measured values of the one or more measured quantities at a second time, and determining the mechanical stress comprises determining the mechanical stress based on a comparison of the one or more first measured values to the one or more second measured values.

In this way, a temporal course of the mechanical stress acting on the inductive component and thus, for example, a point in time for maintenance may be identified.

In some embodiments, the method may further comprise identifying a maintenance requirement of the inductive component and/or one or more elements coupled to the inductive component based on the one or more measured quantities.

Based on the aforementioned measured quantities, a deviation of the mechanical stress from a set point or threshold value may, for example, be identified, which results in a maintenance requirement of the inductive component. The maintenance requirement identified from this indicates, for example, whether the inductive component or elements interacting with the component need to be replaced or maintained.

According to a further aspect, embodiments of the present disclosure relate to a computer program adapted to perform the method described above when executed on a processor.

For example, the computer program may optionally control the applying of the electrical excitation signal to the inductive component and sensing the one or more measured quantities, as well as serve to determine the mechanical stress acting on the inductive component.

It is understood that the program may comprise a plurality of interacting subprograms, each of which may generally run on separate processors.

According to another aspect, embodiments of the present disclosure relate to an apparatus for checking a mechanical stress of an inductive component. The apparatus comprises one or more sensors for sensing one or more measured quantities dependent on the mechanical stress when an electrical excitation signal is applied to the inductive component. Further, the apparatus comprises at least one processor to determine the mechanical stress acting on the inductive component based on the one or more sensed measured quantities.

As previously described, the one or more sensors may comprise a sound transducer, a microphone, a pickup, a current measuring device, and/or a voltage measuring device to identify the one or more measured quantities, and/or values for the one or more measured quantities.

It should also be noted that if “the sensors” are referred to below, they refer to the one or more sensors.

The sensors may be wirelessly or wiredly coupled to the at least one processor to transmit the sensed measured quantities to the processor for determining the mechanical stress acting on the inductive component.

The processor is to be understood as, for example, a central processing unit (CPU), a microcontroller, an integrated circuit, an application-specific integrated circuit (ASIC) or any programmable hardware.

The processor may be configured to identify the stress acting on the inductive component from a relationship or a ratio of the measured quantities to the mechanical stress.

In some embodiments, the one or more measured quantities comprise vibration information about mechanical vibrations of the inductive component when the electrical excitation signal is applied. Accordingly, the at least one processor is configured to determine the mechanical stress based on the vibration information.

As previously described, the vibration information may comprise at least a frequency, a frequency spectrum, an amplitude, or an overtone or undertone of the mechanical vibration.

In some embodiments, the one or more measured quantities dependent on the mechanical stress comprise an electrical impedance of the inductive component. Accordingly, the at least one processor is configured to determine the mechanical stress based on the electrical impedance.

As previously described, the electrical impedance is identified based on an electric voltage and an electric current of the electrical excitation signal.

It should be noted that features previously mentioned in connection with the method are mutatis mutandis transferable to the computer program and/or the apparatus, and vice versa.

### BRIEF DESCRIPTION OF THE FIGURES

Some examples of apparatuses and/or methods will be described in the following by way of example only and with reference to the accompanying figures, in which:

FIG. 1 shows a flowchart schematically illustrating a method for checking a mechanical stress acting on an inductive component;

FIG. 2a shows a schematic representation of a coil in a side view and axial forces acting on the coil;

FIG. 2b shows a schematic representation of a coil in a top view and radial forces acting on the coil;

FIG. 3 is a measurement of mechanical vibrations of the inductive component;

FIG. 4a shows a block diagram schematically illustrating a procedure for obtaining measured quantities for determining the mechanical stress acting on the inductive component;

FIG. 4b shows a block diagram illustrating an inclusion of influencing quantities when determining the mechanical stress;

FIG. 5a shows a diagram illustrating a frequency spectrum of mechanical vibrations of the inductive component;

FIG. 5b shows an analysis of the frequency spectrum;

FIG. 5c shows a determination of a fundamental based on the frequency spectrum;

FIG. 5d shows a determination of a fundamental and the overtones of this fundamental;

FIG. 6 shows a diagram illustrating a temporal course of several temporally successive frequency spectra of the mechanical vibrations of the inductive component; and

FIG. 7 shows an apparatus for checking the mechanical stress acting on the inductive component.

### DESCRIPTION

Various examples will now be described in more detail with reference to the accompanying Figures in which some examples are illustrated. In the Figures, the thicknesses of lines, layers and/or areas may be exaggerated for clarity.

Accordingly, while further examples are capable of various modifications and alternative forms, some particular examples thereof are shown in the Figures and will subsequently be described in detail. However, this detailed description does not limit further examples to the particular forms described. Further examples may cover all modifications, equivalents, and alternatives falling within the scope of the disclosure. Same or like reference numbers refer to like or similar elements throughout the description of the Figures, which may be implemented identically or in modified form when compared to one another while providing for the same or a similar function.

It will be understood that when an element is referred to as being “connected” or “coupled” to another element, the elements may be directly connected or coupled via one or more intervening elements. If two elements A and B are combined using an “or”, this is to be understood as disclosing all possible combinations, i.e., only A, only B as well as A and B, unless explicitly or implicitly defined otherwise. An alternative wording for the same combinations is “at least one of A and B” or “A and/or B”. The same applies, mutatis mutandis, for combinations of more than two Elements.

The terminology used herein for the purpose of describing particular examples is not intended to be limiting for further examples. Whenever a singular form such as “a,” “an,” and “the” is used and using only a single element is neither explicitly or implicitly defined as being mandatory, further examples may also use plural elements to implement the same function. If a function is described below as being implemented using multiple elements, further examples may implement the same function using a single element or a single processing entity. It will be further understood that the terms “comprises”, “comprising”, “includes” and/or “including,” when used, specify the presence of the stated features, integers, steps, operations, processes, elements, components and/or any group of the same, but do not preclude the presence or addition of one or more other features, integers, steps, operations, processes, elements, components and/or any group thereof.

Unless otherwise defined, all terms (including technical and scientific terms) are used herein in their ordinary meaning of the art to which the examples belong.

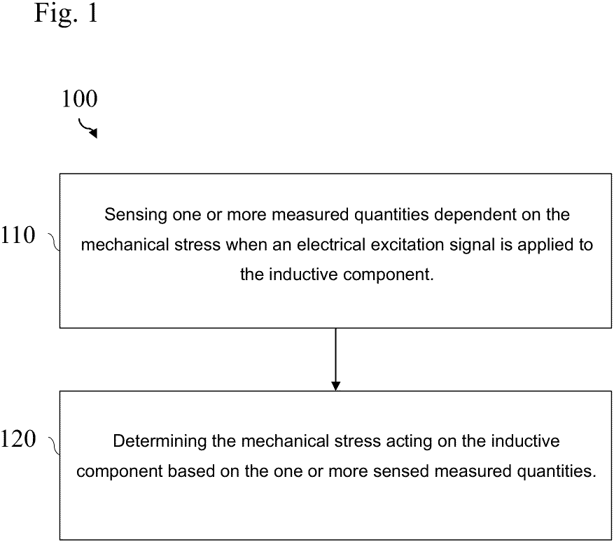

FIG. 1 shows a flowchart schematically illustrating a method 100 for checking a mechanical stress acting on an inductive component.

The method 100 comprises sensing 110 one or more measured quantities dependent on the mechanical stress when an electrical excitation signal is applied to the inductive component.

Further, the method 100 comprises determining 120 the mechanical stress acting on the inductive component based on the one or more sensed measured quantities.

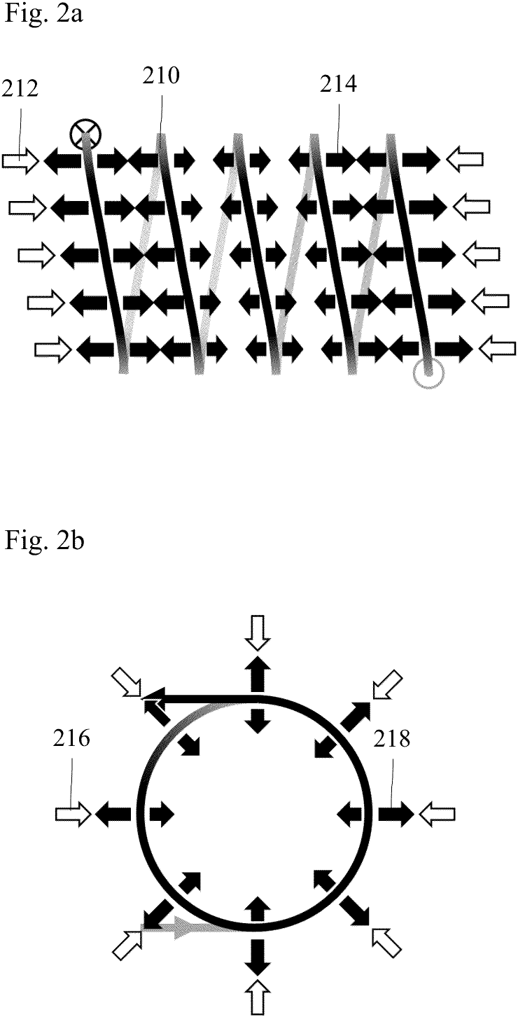

For example, as shown in FIGS. 2a and 2b, the inductive component comprises a coil 210. When the electrical excitation signal is applied, (intrinsic/internally arising) expansion forces 214 acting in axial direction may act on the coil 210 in opposition to prestressing forces 212 acting in the axial direction. In addition, when the electrical excitation signal is applied, (intrinsic/internally arising) expansion forces 218 acting outwards in radial direction may act on the coil 210 in opposition to prestressing forces 216 acting inwards in the radial direction.

To support the coil 210 against the forces 214 and/or 218, the coil 210 may be prestressed with the mechanical stress in the axial and/or the radial direction. For this purpose, the coil 210 is clamped, for example, using screws or bolts between anchors (concrete anchors) located radially outside or inside the coil 210 with the mechanical stress/prestress.

As previously described, to determine any maintenance requirement and/or any wear of the coil 210, it may be desired to check/monitor the mechanical stress/prestress of the coil 210.

The method 100 allows for a sensor-based and/or automatic monitoring of mechanical stress.

In order to sense the measured quantities dependent on the mechanical stress, mechanical vibrations emitted by the coil 210, and/or vibration information of the mechanical vibrations, may be sensed metrologically. The vibration information may comprise at least a part of the measured quantities dependent on the mechanical stress and may be sensed, for example, based on a structure-borne sound or airborne sound generated by the coil 210 when an electrical excitation signal is applied thereto.

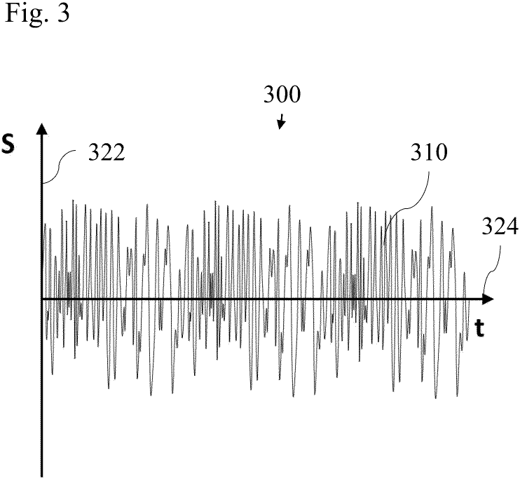

FIG. 3 shows an example of a diagram 300 measuring signal 310 during a measurement of the mechanical vibrations of the coil 210. The measuring signal 310 is plotted against an axis 322 to indicate an amplitude S of the measured structure-borne sound or airborne sound, and a time axis 324 to indicate a time t. The measuring signal 310 may serve to identify vibration information or so-called “frequency content”, such as a frequency, an amplitude, a frequency spectrum and/or undertones and/or overtones of the mechanical vibrations of the coil 210, which are dependent in particular on the mechanical stress acting on the coil 210 and may thus be used as measured quantities for determining the mechanical stress.

In addition to the structure-borne sound and/or airborne sound generated by the coil 210, vibration information may be sensed based on an excitation mechanism of the coil 210. For example, the excitation mechanism comprises supplying electrical energy in the form of the electrical excitation signal to the coil 210 - the frequency content/vibration information may therefore be derived from electrical quantities such as an electric voltage and electric current of the electrical excitation signal applied to the coil 210. Accordingly, the electric voltage, the electric current of the electrical excitation signal, or the electrical impedance of the coil 210 resulting from the electric voltage and the electric current may be used to identify the mechanical stress.

In addition, the electrical impedance is characteristic of an inductance dependent on a cross-section of the coil 210 (which depends on the shape and diameter of the coil 210). Therefore, based on the impedance, changes in the cross-section due to a changed mechanical stress, and thus the mechanical stress acting on the coil 210 may be identified.

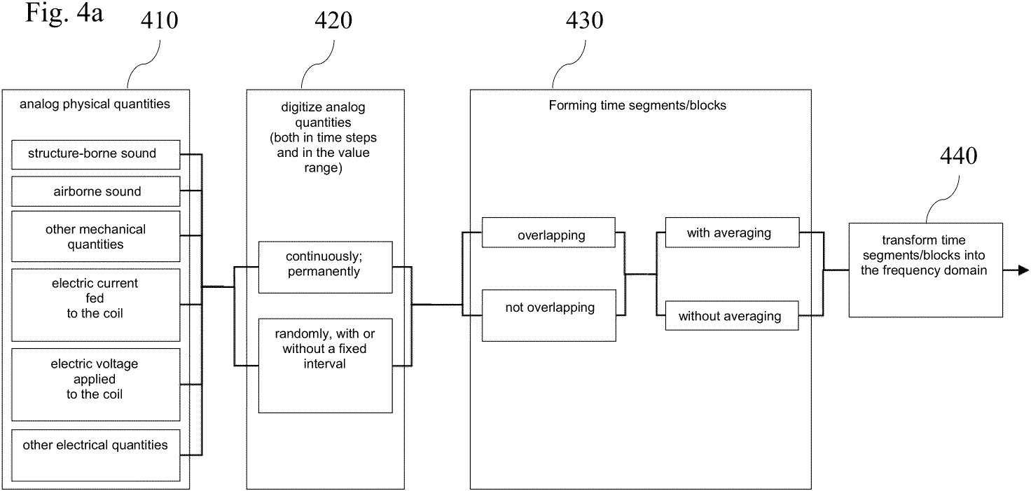

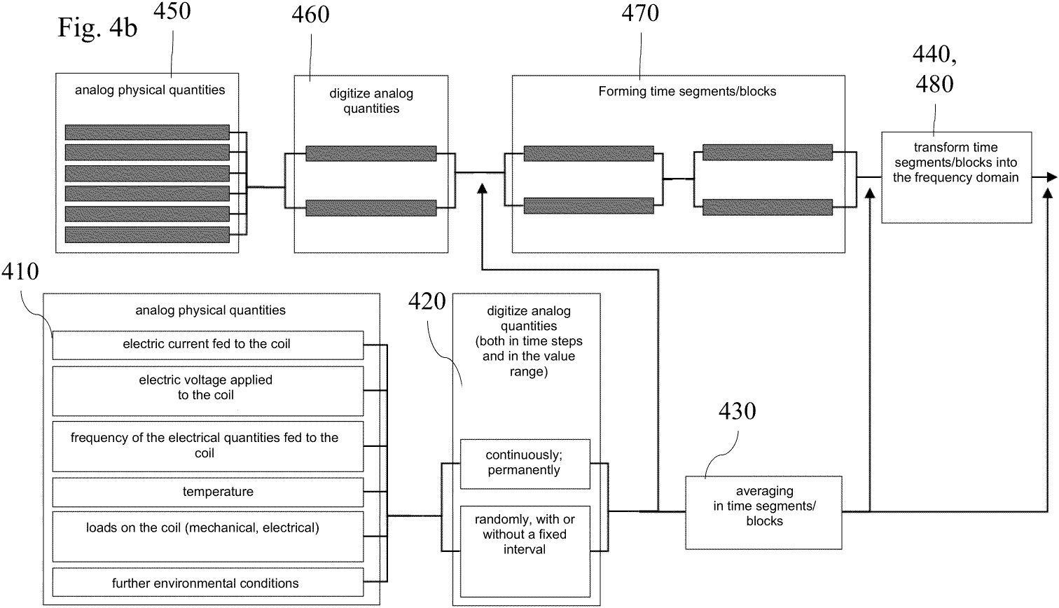

The electrical impedance and the vibration information may be stored on an electronic data storage device and be analyzed with respect to the frequency content of the mechanical vibrations using a processor configured for this purpose. As described below with reference to FIG. 4a and FIG. 4b, the mechanical vibrations may be sensed, stored and the frequency content may be further processed/prepared (e.g., in the form of frequency spectra) on a random basis, at fixed (possibly also overlapping) intervals or on a continuous/ongoing basis.

FIG. 4a shows a block diagram schematically illustrating a procedure for obtaining the measured quantities (for example, the previously mentioned vibration information) suitable for determining the mechanical stress acting on the inductive component.

This procedure provides for sensing 410 analog measuring signals from which the measured quantities may be identified.

For digitizing 420 the measuring signals may be converted into an analog-to-digital converter. The measuring signals fed in may be digitized either permanently/continuously or randomly at a fixed or variable time interval. In the case of continuous digitization, for example, the measuring signals are digitized over a whole or partial time period of the measuring signals. In the case of random digitization, for example, individual measured values of the measuring signals are digitized. Digitizing 420 comprises “a discretization” of the measuring signals in the value as well as in the time range.

In a further step, parts of the digitized measuring signals, and/or the digitized measured values, are assigned 430 to respective individual time segments or time blocks, which either overlap with each other or not. Optionally, an average value of the measured values, and/or of the parts of the digitized measuring signals, which are assigned to the same time segment, may be formed.

(Parts of) measuring signals, average values or measured values of the measuring signals characterizing the mechanical vibrations of the coil 210 processed with the previous steps may be transformed into the frequency domain by a subsequent transformation 440. For example, the transform 440 comprises a Fourier transform. The measured quantities, such as a measured amplitude of the mechanical vibrations of the coil 210, may thus be displayed in the frequency domain and be analyzed as will be explained later.

FIG. 4b shows a block diagram which, in addition to a schematic representation of steps 410, 420 and 430, schematically illustrates sensing 450 analog measuring signals from which influencing quantities may be identified. The influencing quantities have, for example, an influence on physical properties of the coil 210 and/or characterize disturbing influences in sensing the measured quantities and thus have an influence on the measured quantities sensed for determining the mechanical stress.

The influencing quantities comprise, for example, an ambient temperature, a humidity, and/or disturbing noise that interferes with, for example, sensing the airborne sound generated by the coil 210.

In a method step 460 shown in FIG. 4b, the measuring signals of the influencing quantities may be digitized analogously to the digitizing 420 of the measured quantities, assigned to time segments or time blocks in a further method step 470, and optionally transformed into the frequency domain in a subsequent method step 480.

As shown by arrows in FIG. 4b, results of the method steps 460, 470 and 480 for preparing/retaining the influencing quantities may be combined or merged with corresponding results of the steps 420, 430 or 440 for preparing the measured quantities in order to at least partially compensate for the influence of the influencing quantities on the measured quantities.

For example, a frequency spectrum of disturbing noise resulting from method step 480 may be subtracted from a frequency spectrum of the mechanical vibrations of the coil 210 obtained from the measuring signal 310 in order to at least partially compensate for interference caused by the disturbing noise.

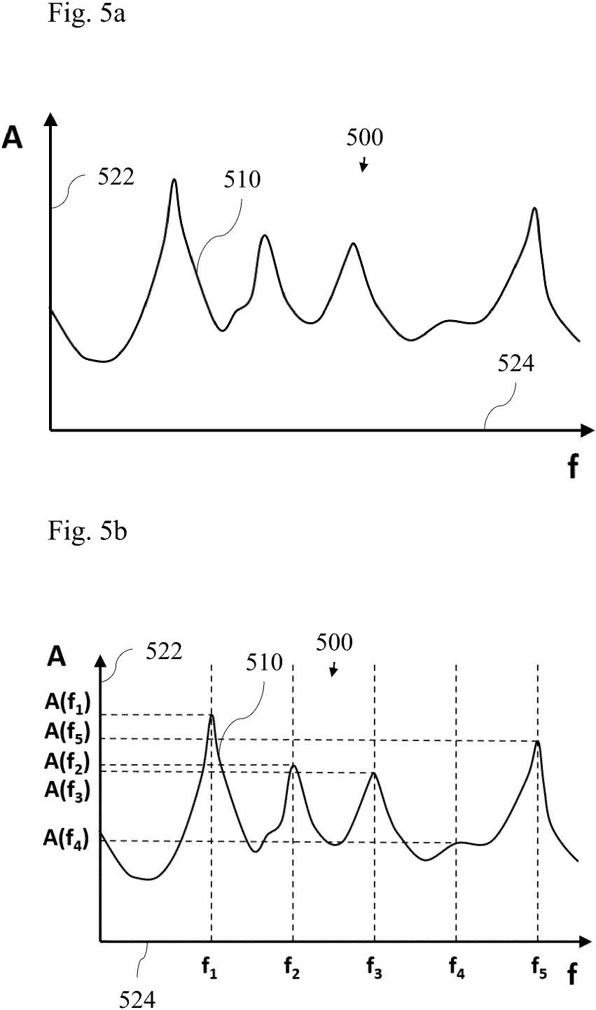

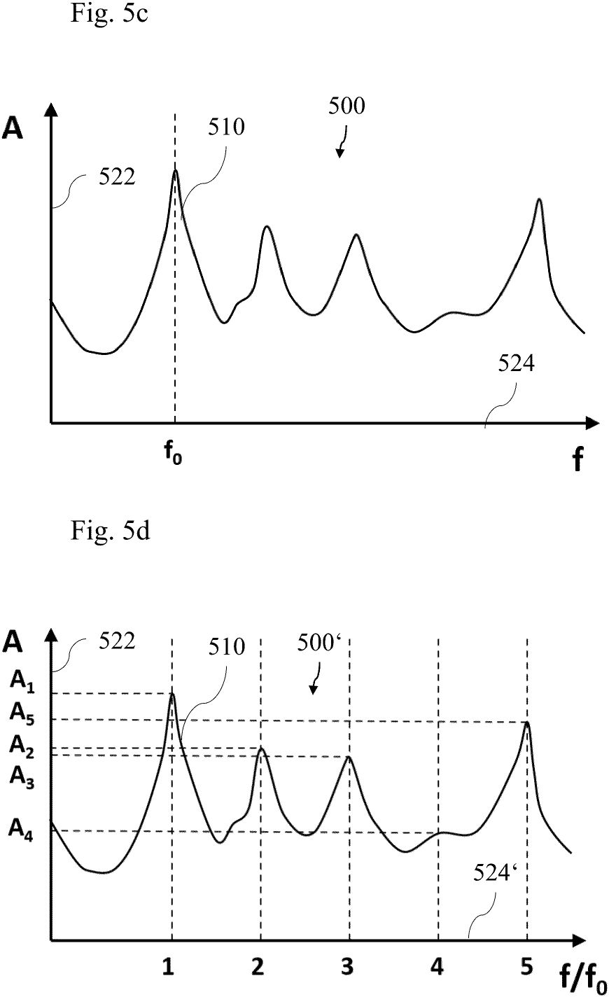

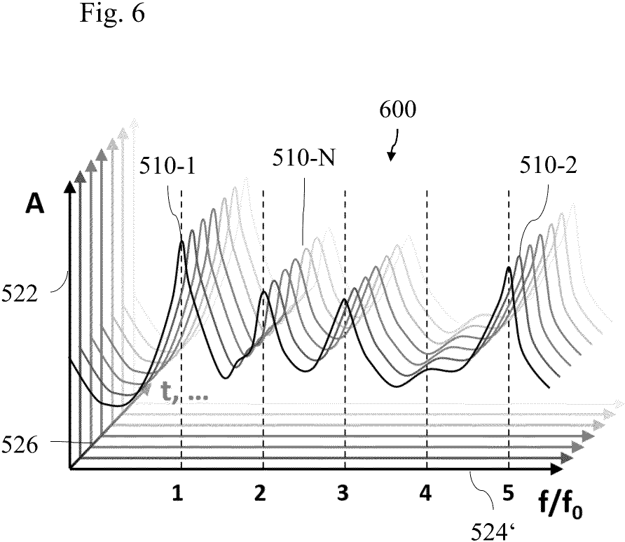

As shown below based on FIG. 5a to FIG. 5d, the frequency content/vibration information may then be analyzed with respect to prominent parts of the frequency content (for example, tones and/or their overtones/undertones). For this purpose, measured quantities such as frequency or amplitude of the mechanical vibrations of the coil 210 are sensed and stored. By forming ratios between amplitudes of various prominent tones and/or overtones, quantities may be determined that reflect a part of an actual structural-dynamic characteristic behavior of the coil 210 and possibly any components interacting with the coil 210. Any changes in the structural-dynamic characteristic behavior (for example, due to a change in prestress) or their absence may be detected by comparing two or more such measurements/analyses, as illustrated in FIG. 5d.

FIGS. 5a, 5b, and 5c show a diagram 500 with an axis 522 indicating a measured vibration amplitude A and an axis 524 indicating a measured frequency of the mechanical vibrations of the coil 210. The diagram 500 represents a digital frequency spectrum 510 of the mechanical vibrations of the coil 210 identified from the measuring signal 310 using the previously mentioned steps 410, 420, 430 and 440.

Based on the frequency spectrum 510, frequencies f₁,..., f₅ are identified, for example, by means of an algorithm or a computer program, at which the frequency spectrum 510 assumes local maxima A(f₁),..., A(f₅). In particular, the frequencies f₁,..., f₅ may indicate a fundamental generated by the mechanical vibrations, an overtone (so-called “harmonic”) and/or an undertone (so-called “subharmonic”).

To determine the mechanical stress, the entire frequency spectrum 510 and/or the local maxima A(f₁),..., A(f₅) may be compared with a frequency spectrum serving as a reference and/or its local maxima, which was sensed with knowledge of the mechanical stress acting on the coil 210.

For example, the frequency spectrum of coil 210 serving as a reference is sensed after setting a certain mechanical stress acting on the coil 210 based on the structure-borne sound or airborne sound generated by coil 210 when the electrical excitation signal is applied. To set the specific mechanical stress, for example, screws used to mechanically prestress the coil 210 are tightened to a predetermined torque.

As may be seen based on FIG. 5c, the local maximum A(f₁), for example, indicates a fundamental of the mechanical vibration with frequency f₀.

FIG. 5d shows a diagram 500′ in which the frequency spectrum 510 is plotted against the axis 522 to indicate the measured vibration amplitude and against an axis 524′ to indicate the measured frequency relative to the frequency f₀ of the fundamental. From the diagram 500′ it follows that the frequencies f₁,..., f₅ of the local maxima A(f₁)/A₁,..., A(f₅)/A₅ correspond to integer divisors 1,..., 5 of the frequency f₀ of the fundamental. The local maxima A₂, ..., A₅, and/or their frequencies f₂,..., f₅ thus indicate undertones/subharmonics to the fundamental with the frequency f₀. Conversely, the local maxima A₁,..., A₄, and/or, may be considered to be overtones/harmonics to the undertone of the local maximum A₅.

Accordingly, the mechanical stress may be identified in particular from values and/or ratios of the fundamental and/or the undertones and/or the overtones.

FIG. 6 shows a diagram 600 in which a plurality of such frequency spectra 510-1, 510-2, ..., 510-N, which were sensed successively in time, are plotted with respect to axes 522, 524′ and with respect to an axis 526 for indicating a time t at which the frequency spectra 510-1, 510-2, ..., 510-N were sensed. Thus, the diagram 600 represents a temporal course of the mechanical vibrations of the coil 210. The diagram 600 may also be referred to as a “spectrogram”.

Therefore, based on the frequency spectra 510-1, 510-2, ..., 510-N or based on deviations of the frequency spectra 510-1, 510-2, ..., 510-N, a change in the mechanical stress of the coil 210 over time may be identified.

The method 100 is therefore suitable, in particular in the form of the embodiment described above, for detecting/determining (temporal) structural-dynamic changes associated with one or more of the following causes and/or effects:
Changes (up to the loss) in the mechanical stress/ prestress of an inductive component, such as the coil 210, which is created, for example, by placing the inductive component on one or more plant elements;
Changing a wall thickness of the one or more plant elements;
Changing layer thicknesses of various internal layers of the one or more plant elements; and
Change in stiffness and/or damping of the one or more plant elements.

The method 100 may therefore also be understood as a metrological method for evaluating the mechanical prestress of components of machines in operation.

In examples of application of the coil 210 as an induction coil in a melting furnace, the one or more plant elements are understood to be, for example, anchors between which the induction coil is clamped, and/or a crucible around which the induction coil is arranged.

In some embodiments, determining the mechanical stress may be performed with different electrical excitation signals applied. For example, the different electrical excitation signals have a different frequency of the applied electric voltage. This may at least partially reduce an influence of the electrical excitation signal when determining the mechanical stress.

The previously described method allows for increased operational safety as well as more efficient utilization of tool lives/service lives of the coil 210 and components interacting with the coil 210.

The method 100 is suitable, for example, for detecting structural-dynamic changes of inductive components and/or components (mechanically) coupled thereto. As described above, the inductive component may be an induction coil of a melting furnace/induction furnace. The components (mechanically) coupled to the induction coil comprise, in particular, anchors for prestressing the induction coil and the crucible arranged inside the induction coil.

Alternatively, the method 100 may be used to identify structural-dynamic properties in further applications/application examples in which one or more inductive components are used. Other applications/application examples comprise:
Mechanical and plant engineering:
Inductive hardening
Electric drives incl. linear drives
Generators
Transformers
(switched) electromagnets
Magnetic bearing
Computed tomography (CT)
Metal detectors
Electrodynamic shakers
Particle accelerator:
with straight-line acceleration; or
with cyclic acceleration (on spiral or rosette-shaped or ring-shaped closed path)
In plants for:
Radiation sterilization
Food irradiation
Electron beam welding
X-ray lithography
Electron beam lithography
The radiographic test
In mass spectrometers
Medical technology
Magnetic resonance imaging
Computed tomography (CT)
Particle accelerators in plant for radiation therapy
Plants for magnetic field therapy
Transportation:
Electric drives incl. linear drives
Electromagnetic levitation systems
Electrodynamic levitation system
Defense Technology:
Gauss gun/rifle
Railgun (more precisely, Electromagnetic Railgun/EMRG)

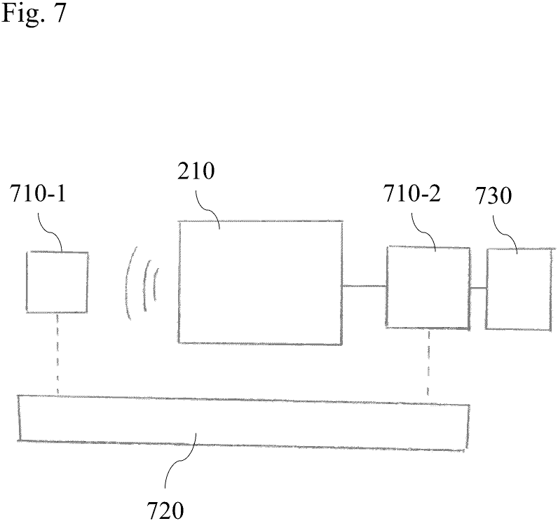

FIG. 7 shows an apparatus configured to perform the previously described method 100 for checking the mechanical stress of an inductive component. The apparatus comprises sensors 710-1 and 710-2 for sensing the measured quantities dependent on the mechanical stress when the electrical excitation signal is applied to the inductive component, which in the example shown comprises the coil 210. In addition, the apparatus comprises a processor 720 for determining the mechanical stress acting on the coil 210 based on the sensed measured quantities.

The electrical excitation signal is applied to the coil 210 by means of a signal generator 730 coupled to the coil 210.

The sensor 710-1 is, for example, a microphone suitable for measuring an airborne sound generated by the coil 210 when the electrical excitation signal is applied to sense vibration information about the mechanical vibrations of the coil 210 based on the measured airborne sound.

For example, the sensor 710-2 comprises a current measuring device and a voltage measuring device for determining an electrical impedance of the coil 210 based on the electrical excitation signal.

Sensors 710-1 and 710-2 are coupled to the processor 720 to transmit vibration information and measured electrical impedance to the processor 720. The processor 720 may be configured to determine the mechanical stress acting on the coil 210 based on the vibration information and/or based on the electrical impedance, as previously described. For this purpose, the processor 720 may execute a computer program adapted for this purpose, which, using the vibration information and the measured electrical impedance as input values, may identify the mechanical stress acting on the inductive component, at least within the limits of measurement inaccuracies and/or measurement errors.

The aspects and features described together with one or more of the previously detailed examples and figures may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Acts, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for example, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and figures merely illustrate the principles of the disclosure. Furthermore, all examples recited herein are principally intended expressly to be only for illustrative purposes to aid the reader in understanding the principles of the disclosure and the concepts contributed by the inventor(s) to furthering the art. All statements herein reciting principles, aspects, and examples of the disclosure, as well as specific examples thereof, include equivalents thereof.

A functional block denoted as “means for ...” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a signal”, “means for generating a signal”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software, but may include digital signal processor (DSP) hardware, a network processor, an application specific integrated circuit (ASIC), a field programmable gate array (FPGA), a read only memory (ROM) for storing software, a random access memory (RAM), and non-volatile storage. Other hardware, conventional and/or custom, may also be comprised.

A block diagram may, for instance, illustrate a rough circuit diagram implementing the principles of the disclosure. Similarly, a flow chart, a flow diagram, a state transition diagram, a pseudo code, and the like may represent various processes, operations or acts, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub-acts may be included and be part of the disclosure of this single act unless explicitly excluded.

Furthermore, the following claims are hereby incorporated into the detailed description, where each claim may stand on its own as a separate example. While each claim may stand on its own as a separate example, it is to be noted that - although a dependent claim may refer in the claims to a specific combination with one or more other claims - other examples may also include a combination of the dependent claim with the subject matter of each other dependent or independent claim. Such combinations are explicitly proposed herein unless it is stated that a specific combination is not intended. Furthermore, it is intended to also include features of a claim for any other independent claim even if this claim is not directly made dependent on the independent claim.

1. A method in particular for checking a mechanical stress acting on an inductive component, the method comprising:
sensing one or more measured quantities dependent on the mechanical stress when an electrical excitation signal is applied to the inductive component; and
determining the mechanical stress acting on the inductive component based on the one or more sensed measured quantities.

2. The method according to claim 1,
wherein the one or more measured quantities comprise vibration information about mechanical vibrations of the inductive component when the electrical excitation signal is applied;
wherein determining the mechanical stress comprises determining the mechanical stress based on the vibration information.

3. The method according to claim 2, wherein the vibration information comprises at least a frequency, a frequency spectrum, an amplitude or fundamental, an overtone or undertone of the mechanical vibration.

4. The method according to claim 2, wherein the method comprises sensing the vibration information based on an airborne sound generated by the inductive component.

5. The method according to claim 2, wherein the method comprises sensing the vibration information based on a structure-borne sound generated by the inductive component.

6. The method according to claim 1,
wherein the one or more measured quantities dependent on the mechanical stress comprise an electrical impedance of the inductive component; and
wherein determining the mechanical stress comprises determining the mechanical stress based on the electrical impedance.

7. The method according to claim 1, wherein determining the mechanical stress based on the one or more measured quantities comprises determining the mechanical stress based on a comparison of the electrical excitation signal to the one or more measured quantities.

8. The method according to claim 1, further comprising identifying one or more influencing quantities that influence the one or more measured quantities when the electrical excitation signal is applied, wherein determining the mechanical stress comprises determining the mechanical stress based on the one or more influencing quantities and the one or more measured quantities.

9. The method according to claim 1, the method further comprising:
configuring a data processing structure for determining the mechanical stress acting on the inductive component based on the one or more measured quantities by means of machine learning using the one or more measured quantities and one or more reference values for the mechanical stress of the inductive component as input quantities for the machine learning.

10. The method according to claim 1,
wherein the inductive component comprises at least one coil on which the mechanical stress acts,
the method comprising:
sensing the one or more measured quantities dependent on the mechanical stress when the electrical excitation signal is applied to the at least one coil; and
determining the mechanical stress acting on the at least one coil based on the one or more sensed measured quantities.

11. The method according to claim 10, wherein the at least one coil is configured to inductively heat a molten material arranged within the at least one coil when the electrical excitation signal is applied to the at least one coil.

12. The method according to claim 1,
wherein sensing the one or more measured quantities comprises sensing one or more first measured values of the one or more measured quantities at a first time and sensing one or more second measured values of the one or more measured quantities at a second time; and
wherein determining the mechanical stress comprises determining the mechanical stress based on a comparison of the one or more first measured values to the one or more second measured values.

13. The method according to claim 1, further comprising identifying a maintenance requirement of the inductive component and/or one or more elements coupled to the inductive component based on the one or more measured quantities.

14. A computer program adapted to execute the method according to claim 1 when executed on a processor.

15. An apparatus for checking a mechanical stress of an inductive component, the apparatus comprising:
one or more sensors for sensing one or more measured quantities dependent on the mechanical stress when an electrical excitation signal is applied to the inductive component; and
at least one processor for determining the mechanical stress acting on the inductive component based on the one or more sensed measured quantities.

16. The apparatus according to claim 15,
wherein the one or more measured quantities comprise vibration information about mechanical vibrations of the inductive component when the electrical excitation signal is applied; and
wherein the at least one processor is configured to determine the mechanical stress based on the vibration information.

17. The apparatus according to claim 15,
wherein the one or more measured quantities dependent on the mechanical stress comprise an electrical impedance of the inductive component; and
wherein the at least one processor is configured to determine the mechanical stress based on the electrical impedance.
